(19) United States
(12) Patent Application Publication
(10) Pub. No.: US 2021/0327328 A1
(43) Pub. Date: Oct. 21, 2021

(54) DISPLAY APPARATUS AND BRIGHTNESS ADJUSTMENT METHOD FOR DISPLAY APPARATUS

(71) Applicants: BOE Technology Group Co., Ltd., Beijing (CN); Chengdu BOE Optoelectronics Technology Co., Ltd., Chengdu (CN)

(72) Inventors: Qianqian LIU, Beijing (CN); Bin ZHANG, Beijing (CN); Chang WANG, Beijing (CN); Tiegang WANG, Beijing (CN); Xiao MA, Beijing (CN); Hui ZHANG, Beijing (CN)

(21) Appl. No.: 17/270,951

(22) PCT Filed: May 11, 2020
(86) PCT No.: PCT/CN2020/089657

§ 371 Date: Feb. 24, 2021

(30) Foreign Application Priority Data
May 24, 2019 (CN) 201910437980.4

(51) Int. Cl. G09G 3/20; G09G 5/10

(52) U.S. Cl. CPC G09G 3/20; G09G 2320/0233; G09G 2320/0626; G09G 5/10

(57) ABSTRACT

Disclosed are a display apparatus and a brightness adjustment method for the display apparatus, which relate to the technical field of display. The display apparatus is configured to enable display of a display screen to be uniform, thus improving the display effect. The method comprises: determining a first total display duration of a first sub-screen of the display screen, and determining a second total display duration of a second sub-screen of the display screen; determining that the first total display duration and the second total display duration meet a preset condition; and adjusting a driving current of the first sub-screen to a first target driving current, and/or adjusting a driving current of the second sub-screen to a second target driving current, such that a difference between the display brightness of the first sub-screen and the display brightness of the second sub-screen is within a pre-determined difference range.

### CROSS REFERENCES TO RELATED APPLICATIONS

The present application is a National Stage of International Application No. PCT/CN2020/089657, filed on May 11, 2020, which claims the priority of Chinese Patent Application No. 201910437980.4, filed with the Chinese Patent Office on May 24, 2019, and entitled “DISPLAY BRIGHTNESS ADJUSTMENT METHOD AND SYSTEM”, the entire content of which is incorporated herein by reference.

### FIELD

The present disclosure relates to the technical field of display, in particular to a display apparatus and a brightness adjustment method for the display apparatus.

### BACKGROUND

Currently, display screens are widely used in various display equipment, such as displays, televisions, mobile phones, and tablet computers. With the development of the display technology, the display methods for a display screen in display equipment are becoming more and more abundant. The display equipment can control its display screen to display on the whole screen, and can also control part of areas in the display screen to display, so that it may cause different degrees of aging of light-emitting devices in the display screen as part of the areas in the display screen are more frequently used while part of the areas are less frequently used, and eventually, the display of the entire display screen is not uniform due to non-uniform light emission, further resulting in a poor display effect.

### SUMMARY

An embodiment of the present disclosure provides a brightness adjustment method for a display apparatus, including: obtaining a first total display duration of a first sub-screen of a display screen and obtaining a second total display duration of a second sub-screen of the display screen, where a folding axis is arranged between the first sub-screen and the second sub-screen; and controlling a power source chip electrically connected to the first sub-screen and the second sub-screen to provide different supply currents to the first sub-screen and the second sub-screen in response to determining that a difference duration between the first total display duration and the second total display duration meets a preset condition, to enable the first sub-screen and the second sub-screen to be consistent in brightness when being displayed on a same plane.

In a possible implementation manner, the controlling the power source chip electrically connected to the first sub-screen and the second sub-screen to provide different supply currents to the first sub-screen and the second sub-screen in response to determining that the difference duration between the first total display duration and the second total display duration meets the preset condition includes: controlling a supply current provided to the first sub-screen by the power source chip to be larger than a supply current provided to the second sub-screen in response to determining that the first total display duration is longer than the second total display duration.

In a possible implementation manner, when the supply current provided to the first sub-screen by the power source chip is controlled to be larger than the supply current provided to the second sub-screen, the method further includes: controlling the supply current provided to the second sub-screen by the power source chip to be unchanged.

In a possible implementation manner, the method further includes: controlling the supply current provided to the second sub-screen by the power source chip to be increased in response to determining that the second total display duration is longer than the first total display duration.

In a possible implementation manner, the controlling the supply current provided to the first sub-screen by the power source chip to be larger than the supply current provided to the second sub-screen further includes: controlling a difference current between the supply current provided to the first sub-screen by the power source chip and the supply current provided to the second sub-screen by the power source chip to be directly proportional to the difference duration.

In a possible implementation manner, the controlling the power source chip electrically connected to the first sub-screen and the second sub-screen to provide different supply currents to the first sub-screen and the second sub-screen includes: controlling the power source chip to provide different supply currents to data lines of the first sub-screen and data lines of the second sub-screen.

In a possible implementation manner, the obtaining the first total display duration of the first sub-screen of the display screen and obtaining the second total display duration of the second sub-screen of the display screen includes: obtaining the first total display duration of the first sub-screen from leaving a factory to a current display moment, and obtaining the second total display duration of the second sub-screen from leaving the factory to the current display moment.

An embodiment of the present disclosure further provides a display apparatus, including: a display screen, including a first sub-screen, a second sub-screen, and a folding axis between the first sub-screen and the second sub-screen; a timer electrically connected to the first sub-screen and the second screen, configured to time a first total display duration of the first sub-screen and a second total display duration of the second sub-screen; a power source chip electrically connected to the first sub-screen and the second sub-screen; and a controller electrically connected to the power source chip, the first sub-screen, the second sub-screen and the timer, configured to obtain the first total display duration and the second total display duration, and control the power source chip to provide different supply currents to the first sub-screen and the second sub-screen in response to determining that a difference duration between the first total display duration and the second total display duration meets a preset condition, to enable the first sub-screen and the second sub-screen to be consistent in brightness when being displayed on a same plane.

In a possible implementation manner, the timer includes a first timer and a second timer; the first timer is configured to time the first total display duration of the first sub-screen, and the second timer is configured to time the second total display duration of the second sub-screen.

In a possible implementation manner, the controller is specifically configured to control the supply current output to the first sub-screen by the power source chip to be larger than the supply current output to the second sub-screen by the power source chip in response to determining that the first total display duration is longer than the second total display duration.

### BRIEF DESCRIPTION OF THE DRAWINGS

In order to illustrate technical solutions in embodiments of the present disclosure or the related art more clearly, the accompanying drawings required for light emission in description of the embodiments will be briefly introduced below. Obviously, the accompanying drawings in the following description are merely some of the embodiments of the present disclosure.

FIG. 1 is a schematic diagram of the architecture of a display brightness adjustment system provided by an embodiment of the present disclosure.

FIG. 2 is a schematic diagram of respective display areas in a non-foldable display screen provided by an embodiment of the present disclosure.

FIG. 3 is a schematic diagram of respective display areas in a foldable display screen provided by an embodiment of the present disclosure.

FIG. 4 is a flowchart of a display brightness adjustment method provided by an embodiment of the present disclosure.

FIG. 5 is a flowchart of a specific display brightness adjustment method provided by an embodiment of the present disclosure.

### DETAILED DESCRIPTION OF THE EMBODIMENTS

In order to make objectives, technical solutions and advantages of the present disclosure clearer, the technical solutions of the present disclosure will be clearly and completely described below in conjunction with the accompanying drawings in the embodiments of the present disclosure. Apparently, the embodiments described are part of the embodiments of the technical solutions of the present disclosure, instead of all the embodiments. All other embodiments obtained by those of ordinary skill in the art based on the embodiments stated in the document of the present disclosure without creative efforts fall within the protective scope of the technical solutions of the present disclosure.

The terms “first” and “second” in the specification and claims of the present disclosure and the above accompanying drawings are configured to distinguish different objects, but are not configured to describe a specific sequence. In addition, the term “include” and any variations thereof are intended to cover non-exclusive protection. For example, a process, method, system, product or equipment that includes a series of steps or units is not limited to the listed steps or units, but optionally further includes unlisted steps or units, or optionally further includes other steps or units inherent in the process, method, product or equipment. In the embodiments of the present disclosure, “multiple” may represent at least two, for example, it may be two, three or more, which is not limited in the embodiments of the present disclosure.

In addition, the term “and/or” herein is only an association relationship describing associated objects, indicating that there may be three relationships, for example, A and/or B, which indicates three cases: only A exists, A and B exist at the same time, and only B exists. Moreover, the character “/” herein generally indicates that the adjacently associated objects are in an “or” relationship in the case of not specifically stated.

For facilitating understanding, the technical background of the embodiments of the present disclosure will be introduced below first.

In the related art, as mentioned above, a display screen can wholly be used to display, or only a part of display area is controlled to display while the other part of area is in a sleep state. In this case, the display durations of the display areas in the display screen are different, so that the degrees of aging of light-emitting devices corresponding to the display areas are different, and further the display screen has technical problems of non-uniform display and poor display effect when the whole screen is used to display.

In view of this, the inventors of the present disclosure provide a brightness adjustment solution for a display apparatus. In this solution, when the display of the display screen is not uniform, the difference of the display brightness of the display areas in the display screen can be maintained within a pre-determined brightness range by adjusting the driving current of each sub-display screen in the display screen, thereby reducing and even eliminating non-uniform display in the different display areas, and enhancing the display effect of the display screen.

In order to better understand the above technical solutions, the above technical solutions will be described in detail below in conjunction with the accompanying drawings of the specification and specific implementation manners.

An embodiment of the present disclosure provides a brightness adjustment system for a display apparatus. Referring to FIG. 1, the display apparatus in the embodiments of the present disclosure includes: a display screen 13, a timer 12, a power source chip 11 and a controller 10.

The display screen 13 includes a first sub-screen 131, a second sub-screen 132, and a folding axis (as shown by a dotted line in the figure) between the first sub-screen 131 and the second sub-screen 132.

The timer 12 is electrically connected to both the first sub-screen 131 and the second sub-screen 132, and configured to time a first total display duration of the first sub-screen 131 and time a second total display duration of the second sub-screen 132. Specifically, the timer 12 further includes a first timer and a second timer, where the first timer is configured to time the total display duration of the first sub-screen and the second timer is configured to time the total display time of the second sub-screen.

The power source chip (Power IC) 11 is electrically connected to the first sub-screen 131 and the second sub-screen 132.

The controller 10 is electrically connected to the power source chip 11, the first sub-screen 131, the second sub-screen 132 and the timer 12. The controller 10 is configured to obtain the first total display duration and the second total display duration, and control the power source chip 11 to provide different supply currents to the first sub-screen 131 and the second sub-screen 132 when it is determined that a difference duration between the first total display duration and the second total display duration meets a preset condition, so that the first sub-screen 131 and the second sub-screen 132 are consistent in brightness when being displayed on a same plane. Specifically, the controller 10 is specifically configured to control a supply current output to the first sub-screen 131 by the power source chip 11 to be larger than a supply current output to the second sub-screen 132 by the power source chip 11 when it is determined that the first total display duration is longer than the second total display duration.

The display screen 13 may be a display screen made using an organic light-emitting diode (OLED) technology, that is, the display screen 13 may be an OLED display screen. The OLED display screen is provided with self-luminous organic electroluminescent diodes without requiring a backlight, and can be made into a flexible panel which has foldable bendability, that is to say, the OLED display screen can be made into a foldable display screen.

Of course, the display screen 13 may also adopt other screens capable of displaying, which is not limited in the embodiments of the present disclosure.

In the embodiments of the present disclosure, the display screen 13 may be divided into two or more display areas. As shown in FIG. 1, the display screen 13 is divided into two display areas, i.e., the first sub-screen 131 and the second sub-screen 132, the first sub-screen 131 and the second sub-screen 132 directly have the folding axis (as shown by the dotted line in the figure). The controller 10 is connected to the power source chip 11, the timer 12 and the display screen 13 respectively. The power source chip 11 includes at least two output ends, and the at least two output ends are one-to-one corresponding to multiple display areas included in the display screen 13. For example, one of the output ends is connected to the first sub-screen 131 and is configured to provide a driving current to the first sub-screen 131, and the other output end is connected to the second sub-screen 132, and is configured to provide a driving current to the second sub-screen 132. The timer 12 can time the display durations of the first sub-screen 131 and the second sub-screen 132 of the display screen 13 respectively.

In the embodiments of the present disclosure, the controller 10 may be integrated with a control chip, and the controller 10 may control the whole display screen 13 to display, or may control part of the display areas in the display screen 13 to display. For example, the controller 10 may control the first sub-screen 131 or the second sub-screen 132 as shown in FIG. 1 to display respectively, or may control the first sub-screen 131 and the second sub-screen 132 to display simultaneously. The power source chip 11 is configured to provide a driving current to the display screen 13 to enable the display screen 13 to emit light for display. The controller 10 may control the power source chip 11 to provide a driving current to the area required to display according to the area of the display screen 13 needing to display. The timer 12 is configured to time the display duration of each display area divided for the display screen 13, for example, a duration that the timer 12 times for the first sub-screen 131 may be called the first total display duration, and a duration that the timer 12 times for the second sub-screen 132 may be called the second total display duration.

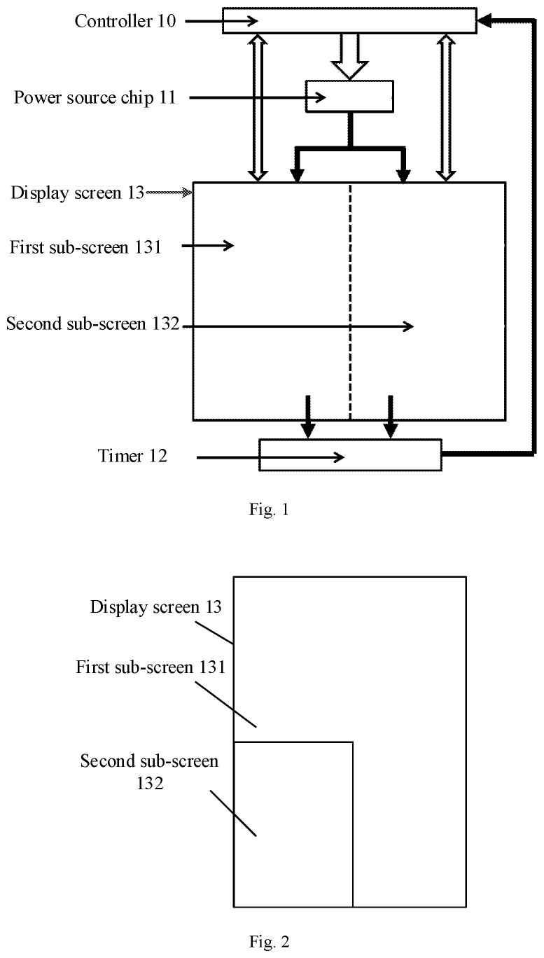

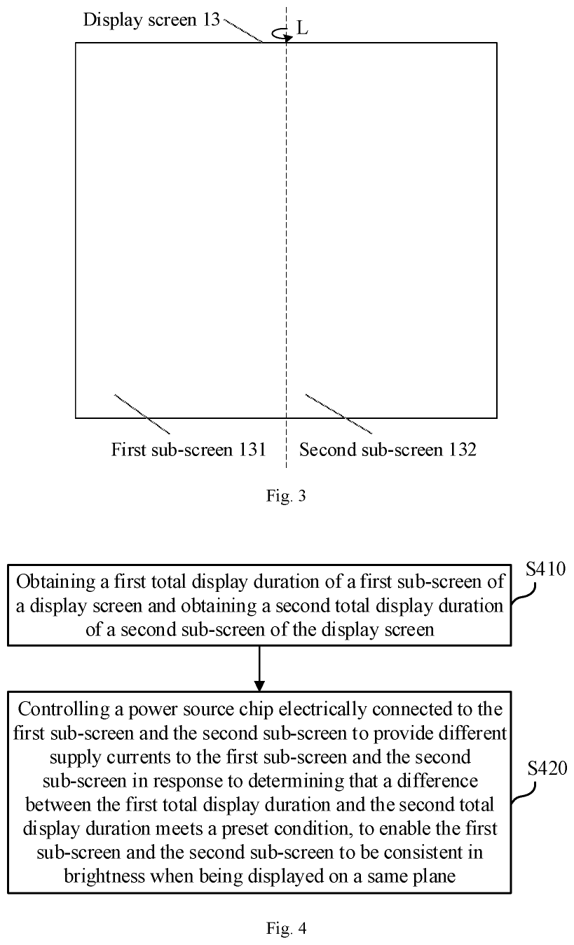

Specifically, referring to FIGS. 2 and 3, the display screen 13 may be a non-foldable screen as shown in FIG. 2 or a foldable screen as shown in FIG. 3. When the display screen 13 is the non-foldable screen as shown in FIG. 2, the display screen 13 can be divided into the first sub-screen 131 and the second sub-screen 132 shown in FIG. 2. It should be noted that division of the first sub-screen 131 and the second sub-screen 132 shown in FIG. 2 is only illustrative. In a specific implementation process, the first sub-screen 131 and the second sub-screen 132 may also be divided in other form and proportion, which are not limited in the embodiment of the present disclosure. Therefore, the controller 10 may control the power source chip 11 to only provide a driving current to the first sub-screen 131 to drive the first sub-screen 131 to display, or only provide a driving current to the second sub-screen 132 to drive the second display area to display, and also the power source chip 11 may be controlled to provide currents to the first sub-screen 131 and the second sub-screen 132 simultaneously, so that the whole display screen 13 is used to display. That is to say, after the display screen 13 is divided into the multiple display areas, the controller 10 may control the power source chip 11 to separately provide a driving current to each display area, so that the display screen 13 may be controlled to be partially brightened for display or to wholly display to meet differentiated display needs of users. Furthermore, the controller 10 may also control the timer 12 to time the first sub-screen 131 and the second sub-screen 132 respectively.

When the display screen 13 is a foldable display screen 13, the foldable display screen 13 may be divided into two sub-screens, i.e., a first sub-screen and a second sub-screen, by using a folding line L shown in FIG. 3 as a dividing line; a display area corresponding to the first sub-screen may be referred to as the first sub-screen 131, and a display area corresponding to the second sub-screen may be referred to as the second sub-screen 132, where a ratio of the two sub-screens in the display screen 13 may be any ratio, for example, a ratio of 1:1 as shown in FIG. 3. The controller 10 can control the power source chip 11 to provide driving currents to the first sub-screen 131 and the second sub-screen 132 of the display screen 13 simultaneously, so that the first sub-screen and the second sub-screen of the display screen 13 display together, i.e., double-screen display; or the controller may also control the power source chip 11 to provide a driving current to the first sub-screen 131 or the second sub-screen 132 of the display screen 13 respectively, so as to control the first sub-screen 131 or the second sub-screen 132 to display separately, i.e., single-screen display. Furthermore, the controller 10 may also control the timer 12 to time the first sub-screen 131 and the second sub-screen 132 respectively.

Of course, the display screen 13 may also be divided into more than two sub-screens, for example, three sub-screens or four sub-screens, and the principle of the display control mode of the multiple sub-screens is similar to that of the display control mode of the two sub-screens. In the embodiments of the present disclosure, the case of two sub-screens is taken as an example for illustration, and the case of more sub-screens is not described in detail.

In specific implementation, the number of timers included in the timer 12 may be the same as or different from the number of display areas divided in the display screen 13. When the number of the timers is the same as the number of the display areas, each display area is connected to a timer, and one timer may time the display duration of a corresponding display area through a one-to-one corresponding manner. For example, as described above, the display screen 13 is divided into the first sub-screen 131 and the second sub-screen 132, the first sub-screen 131 is connected to a first timer, the second sub-screen 132 is connected to a second timer, and the first timer and the second timer respectively time the display duration of the first sub-screen 131 and the display duration of the second sub-screen 132.

Based on the display apparatus introduced above, an embodiment of the present disclosure provides a brightness adjustment method for a display apparatus. As shown in FIG. 4, the specific flows of the method are described as follows.

Step 401: a first total display duration of a first sub-screen 131 of a display screen 13 is obtained, and a second total display duration of a second sub-screen 132 of the display screen 13 is obtained.

The first sub-screen 131 and the second sub-screen 132 have a folding axis L, and the first sub-screen 131 and the second sub-screen 132 are foldable around the folding axis. Specifically, the first total display duration can be understood as a total display duration of the first sub-screen from leaving a factory to a current display moment, and the second total display duration can be understood as a total display duration of the second sub-screen from leaving the factory to the current display moment, that is, the step S401 that the first total display duration of the first sub-screen 131 of the display screen 13 is obtained and the second total display duration of the second sub-screen 132 of the display screen 13 is obtained may specifically include: obtaining the first total display duration of the first sub-screen 131 from leaving the factory to the current display moment, and obtaining the second total display duration of the second sub-screen 132 from leaving the factory to the current display moment.

Specifically, for facilitating illustration, in conjunction with the display apparatus shown in FIG. 1, the example as shown in FIG. 3 that the display screen 13 is divided into the first sub-screen 131 and the second sub-screen 132 is specifically described. As mentioned above, the first total display duration of the first sub-screen 131 and the second total display duration of the second sub-screen 132 in the display screen 13 may be timed respectively by a timer, so that a controller may obtain the first total display duration of the first sub-screen 131 and the second total display duration of the second sub-screen 132 from the timer.

For example, the display screen 13 in a foldable mobile terminal is a foldable screen. When a user is using the foldable mobile terminal, the foldable mobile terminal may be unfolded for use, that is, the display is performed through the whole display screen 13, or the foldable mobile terminal may be folded for use, that is, the display is performed through part of display areas in the display screen 13. Therefore, when the foldable mobile terminal is used in a folded state for a long time, it is prone to increasing the degree of aging and reducing the light-emitting frequency of light-emitting devices corresponding to the part of the display areas frequently used due to the long use time of the part of the display areas frequently used in the foldable screen, further resulting in non-uniform display of the part of the display areas frequently used and the part of the display areas infrequently used in the foldable screen.

Step 402: a power source chip electrically connected to the first sub-screen and the second sub-screen is controlled to provide different supply currents to the first sub-screen 131 and the second sub-screen 132 when it is determined that a difference duration between the first total display duration and the second total display duration meets a preset condition, so that the first sub-screen 131 and the second sub-screen 132 are consistent in brightness when being displayed on a same plane. Specifically, for an organic light-emitting display panel, its supply current is related to a difference (Vdd−Vdata) between a power voltage and a data voltage, that is, the supply current may be reduced by increasing the power voltage or reducing the data voltage. If adjustment of the power current is realized by increasing the power voltage, the folding display screen requires two separate controller chips to realize the adjustment, which is not conducive to the production cost of the folding display screen. Further, in specific implementation, the adjustment of the supply current may be realized by adjusting the data voltage, that is, the step that the power source chip electrically connected to the first sub-screen and the second sub-screen is controlled to provide different supply currents to the first sub-screen and the second sub-screen in the step S420 includes: controlling the power source chip to provide different supply currents to one or more data lines of the first sub-screen and one or more data lines of the second sub-screen.

In the embodiments of the present disclosure, since the light-emitting devices in the display screen 13 will age with the increase of working time, where the working time is longer, the degree of aging is higher, and the light-emitting efficiency of the light-emitting devices is increasingly lower, and further when degrees of aging of different display areas are different and reach a certain level, problems of non-uniform display and poor display effect may occur between the different display areas. Therefore, the current display brightness of the first sub-screen 131 and the second sub-screen 132 can be determined based on the first total display duration of the first sub-screen 131 and the second total display duration of the second sub-screen 132 in the display screen 13, so as to determine whether the first sub-screen 131 and the second sub-screen 132 have problems of non-uniform display and poor display effect.

Specifically, the step S420 that a power source chip electrically connected to the first sub-screen and the second sub-screen is controlled to provide different supply currents to the first sub-screen and the second sub-screen when it is determined that the difference duration between the first total display duration and the second total display duration meets the preset condition includes: step S4201, controlling the supply current provided to the first sub-screen by the power source chip to be larger than the supply current provided to the second sub-screen by the power source chip. Generally speaking, the longer the display time of the display screen is, the lower the brightness is. In the embodiments of the present disclosure, when the first total display duration of the first sub-screen 131 is longer than the second total display duration of the second sub-screen 132, consistent brightness of the first sub-screen 131 and the second sub-screen 132 may be realized by providing a higher supply current to the first sub-screen 131.

In specific implementation, when the step S4201 is performed, that is, when a supply current provided to the first sub-screen by the power source chip is controlled to be larger than a supply current provided to the second sub-screen by the power source chip, the method further includes the step that the supply current provided to the second sub-screen by the power source chip is controlled to be unchanged.

In the embodiments of the present disclosure, the supply current of the sub-display screen with a longer display duration is increased to enable the display brightness of different sub-screens to be consistent, and the brightness of the sub-display screen with a shorter display duration may not be adjusted, that is, the sub-screen with the shorter display duration is maintained to work with the supply current originally provided, while the supply current of the sub-screen with the longer display duration may be increased, so that the two sub-screens are consistent in brightness.

In specific implementation, when the step S4201 is performed, the brightness adjustment method provided by the embodiments of the present disclosure further includes the step that the supply current provided to the second sub-screen by the power source chip is controlled to be increased when it is determined that the second total display duration is longer than the first total display duration.

In the embodiments of the present disclosure, the supply current of the sub-display screen with a longer display duration is increased to enable the display brightness of different sub-display screens to be consistent. For the one of the two sub-screens whose total display duration is shorter, if its total display duration exceeds a certain range (i.e., the first total display duration, which can be the total display duration of the second sub-screen from leaving the factory to the current display moment when the brightness of the second sub-screen is lower than a preset brightness), it can be believed that both of the two sub-screens are used for a long time, that is, the light-emitting brightness of the two sub-screens are both lower than a normal display brightness. In this case, in order to improve user's experience and enable human eyes to have a better viewing effect, the display brightness of the sub-screen with a shorter total display duration may also be increased. Of course, even if the supply current of the sub-screen with a shorter total display duration is also increased, the supply current is still smaller than the supply current of the display sub-screen with a longer total display duration to maintain consistent brightness of the two sub-screens.

In specific implementation, the step S4201 of controlling the supply current provided to the first sub-screen by the power source chip to be larger than the supply current provided to the second sub-screen by the power source chip includes: controlling the difference current between the supply currents provided to the first sub-screen and the second sub-screen by the power source chip to be directly proportional to the difference duration. In the embodiments of the present disclosure, the difference current between the supply currents provided to the first sub-screen and the second sub-screen is directly proportional to the display difference duration between the first sub-screen and the second sub-screen, that is, the greater the difference duration between the two sub-screens is, the larger the difference current is, so as to further enable the display brightness of the two sub-screens to be consistent.

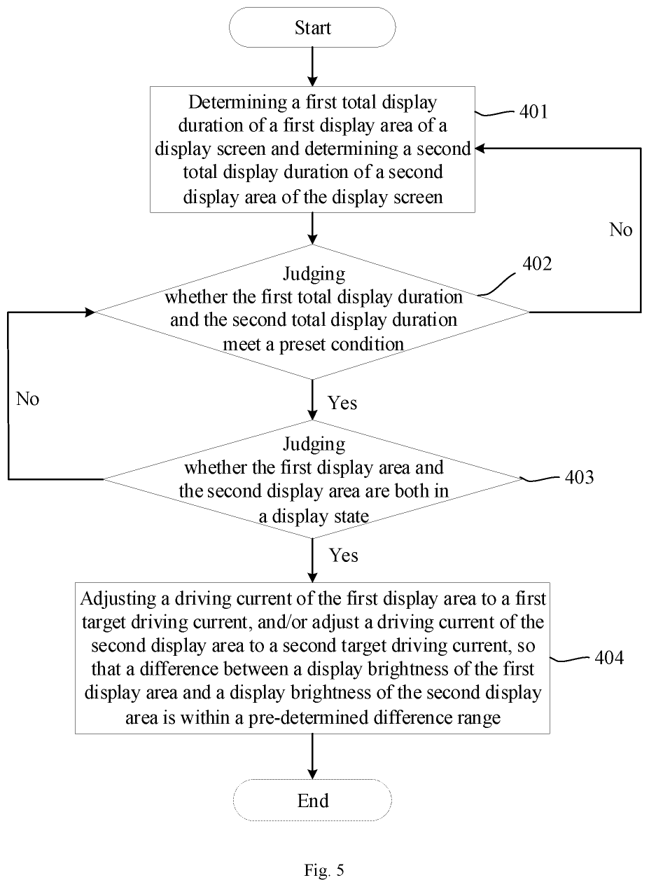

In order to more clearly understand the brightness adjustment method for the display apparatus provided in the embodiments of the present disclosure, the brightness adjustment method provided by the embodiments of the present disclosure is exemplified as follows by taking FIG. 5 as an example.

Step 401: a first total display duration of a first sub-screen 131 of a display screen 13 is obtained and a second total display duration of a second sub-screen of the display screen 13 is obtained. Specifically, the first total display duration of the first sub-screen 131 and the second total display duration of the second sub-screen 132 may be timed by a timer, and then the first total display duration and the second total display duration are sent to a controller, and furthermore, the controller may obtain the first total display duration and the second total display duration.

Step 402: whether the first total display duration and the second total display duration meet a preset condition is judged.

Further, it can be determined whether the display screen 13 has a non-uniform display case by determining whether the difference duration between the first total display duration of the first sub-screen 131 and the second total display duration of the second sub-screen 132 meets the preset condition, where the preset condition is a critical condition that non-uniform display of the first sub-screen 131 and the second sub-screen 132 starts to appear. For facilitating understanding, several cases are listed below for illustration.

First case: it is determined that the preset condition is met if the first total display duration is unequal to the second total display duration, that is, the difference duration is not zero.

In the embodiments of the present disclosure, with the increase of light-emitting time, the light-emitting efficiency of light-emitting devices in the display screen 13 will attenuate. The longer the use time is, the greater the degrees of aging of the light-emitting devices in the display screen 13 are, and the greater attenuation degree of the light-emitting efficiency. Therefore, when the use time of the first sub-screen 131 is different from the use time of the second sub-screen 132, the light-emitting devices corresponding to the first sub-screen 131 and the second sub-screen 132 are also different in light-emitting efficiency, and also definitely different in brightness, so that the case of non-uniform display may occur easily, and furthermore it is necessary to adjust the display brightness of the first sub-screen 131 and/or the second sub-screen 132.

Second case: it is determined that the preset condition is met if the difference duration between the first total display duration and the second total display duration is more than or equal to a first preset difference.

In specific implementation, the display effect is mainly an effect of user's visual perception brought by an image presented by the display screen 13. If the display brightness difference between the display areas in the display screen 13 is small, the visual difference brought to the user is not too large either, and human eyes cannot perceive display changes between the various display areas, and then naturally it is not necessary to adjust the brightness of the display screen 13. Therefore, in the embodiments of the present disclosure, a minimum brightness difference that a user can find the situation of non-uniform display of the display screen 13 can be determined according to the visual sensitivity of human eyes, and furthermore the minimum time for generating the brightness difference is determined.

That is to say, when the user starts to perceive the non-uniform display of the display screen 13, the difference duration between the first total display duration of the first sub-screen 131 and the second total display duration of the second sub-screen 132 may be taken as a first preset difference. If the finally determined difference duration between the first total display duration of the first sub-screen 131 and the second total display duration of the second sub-screen 132 is less than the first preset difference, it can indicate that display of the display screen 13 is not uniform at the moment, which is in a range that cannot be perceived by the user's eyes, and it is unnecessary to adjust the display brightness of each display area. If the finally determined difference between the first total display duration and the second total display duration is more than or equal to the preset time difference range, it can indicate that the display of the display screen 13 is not uniform at the moment, which can be perceived by user's eyes, and it is necessary to adjust the display brightness of each display area. Therefore, waste of power resulted from frequent adjustment of the display brightness of each display area in the display screen 13 can be avoided, and thus electric energy can be saved while the display effect is improved.

Third case: it is determined that the preset condition is met if the maximum duration in the first total display duration and the second total display duration is longer than a preset duration and the difference duration between the first total display duration and the second total display duration is more than or equal to a second preset difference.

In specific implementation, the longer the total display time of the display screen 13 is, the faster its aging rate is. For example, the aging rate of the display screen 13 just after leaving the factory is not the same as that of the display screen 13 after being used for a period of time, then the display brightness change of the display screen 13 is also little when the total display time of the display screen 13 is short, so that it is possible that the user can observe the situation of non-uniform display when the difference between the display durations of the first sub-screen 131 and the second sub-screen 132 is large, and after using for a period of time, as the aging rate of the display screen 13 increases, it is possible that the user can perceive the situation of non-uniform display of the display screen 13 when the difference between the display durations of the first sub-screen 131 and the second sub-screen 132 is small.

Therefore, a pre-determined duration can be set according to the change trend of the aging rate of the light-emitting devices in the display screen 13. With the pre-determined duration as a boundary, the change of the aging rate of the light-emitting devices in the display screen 13 is little before the pre-determined duration is reached, and the change of the aging rate of the light-emitting devices in the display screen 13 increases when the pre-determined duration is exceeded. Then, when the maximum duration in the first total display duration of the first sub-screen 131 and the second total display duration of the second sub-screen 132 is longer than the pre-determined duration and the difference between the first total display duration and the second total display duration is more than or equal to the second preset difference, it is determined that bright adjustment is required. At the moment, a time interval for display brightness adjustment is shorter than that for display brightness adjustment in the second case.

For example, it is assumed that the pre-determined duration is 10,000 hours, and then the aging rate of the light-emitting devices in the display screen 13 within 10,000 hours is lower than the aging rate of the light-emitting devices in the display screen 13 after more than 10,000 hours. Therefore, within 10,000 hours, the first preset difference can be set as 800 hours, and when the difference between the first total display duration and the second total display duration is set to be more than or equal to 800 hours, it is determined that the preset condition is met and brightness adjustment is required. When the maximum duration in the first total display duration and the second total display duration exceeds 10,000 hours, the second preset difference can be set as 400 hours, and then when the difference between the first total display duration and the second total display duration is set to be more than or equal to 400 hours, it is determined that the preset condition is met and brightness adjustment is required. It can be seen that the frequency of brightness adjustment of the display screen 13 within 10,000 hours is less than the frequency of brightness adjustment of the display screen 13 after more than 10,000 hours, therefore, the frequency of brightness adjustment of the display screen 13 can be determined according to the use time of the display screen 13 to reduce the frequency of brightness adjustment of each display area in the display screen 13, thereby improving the display effect of the display screen 13.

Step 403: whether the first sub-screen 131 and the second sub-screen 132 are both in a display state is judged.

In the embodiments of the present disclosure, whether it is necessary to adjust the current display brightness of each display area in the display screen 13 may be judged when each display area in the display screen 13 is in a display state, or when each display area in the display screen 13 is in an off-screen state, or when part of the areas are in the display state and the other part of the areas are in the off-screen state. When the display screen 13 is in the off-screen state, or part of the areas are in the display state while part of the areas are in the off-screen state, it is not necessary to adjust the brightness of each display area in the display screen 13. Therefore, it can be determined first whether the display areas in the display screen 13 are in the display state, before the brightness of each display area in the display screen 13 is adjusted, that is, whether the first sub-screen 131 and the second sub-screen 132 are both in the display state is determined, and if the first sub-screen 131 and the second sub-screen 132 are both in the display state, step 404 is performed.

Step 404: a driving current of the first sub-screen 131 is adjusted to a first target driving current, and/or a driving current of the second sub-screen 132 is adjusted to a second target driving current, so that a difference between the display brightness of the first sub-screen 131 and the display brightness of the second sub-screen 132 is within a pre-determined difference range, which can be understood as a range in which brightness is consistent when being viewed by human eyes.

In the embodiments of the present disclosure, the larger the driving currents of the light-emitting devices in the display screen 13 are, the brighter light-emitting brightness thereof are, that is to say, the larger the driving current of the display screen 13 is, the brighter the display brightness of the display screen 13 is. When aging of the light-emitting devices in the display screen 13 occurs, the display brightness decreases. Therefore, the display brightness of the display screen 13 may be increased by increasing the driving current of the display screen 13. Then, when the display brightness of the display areas in the display screen 13 may be different to result in that the user can perceive the non-uniform display between the display areas in the display screen 13, the uniform display of the display screen 13 can be realized by adjusting the driving current of each display area, thus improving the display effect of the display screen 13.

In specific implementation, a first target driving current of the first sub-screen 131 can be determined, and the difference between the display brightness of the first sub-screen 131 and the display brightness of the second sub-screen 132 can be within a pre-determined difference range by adjusting the driving current of the first sub-screen 131 to the first target driving current, that is to say, the uniform display of the first sub-screen 131 and the second sub-screen 132 can be realized by only adjusting the driving current of the first sub-screen 131; the second target driving current of the second sub-screen 132 also can be determined, and the difference between the display brightness of the second sub-screen 132 and the display brightness of the first sub-screen 131 can be within a pre-determined range by adjusting the driving current of the second sub-screen 132 to the second target driving current, that is to say, the uniform display of the first sub-screen 131 and the second sub-screen 132 can be realized by only adjusting the driving current of the second sub-screen 132; the first target driving current of the first sub-screen 131 and the second target driving current of the second sub-screen 132 can also be determined simultaneously, and the difference between the display brightness of the first sub-screen 131 and the display brightness of the second sub-screen 132 can be within the pre-determined difference range by adjusting the driving current of the first sub-screen 131 to the first target driving current and adjusting the driving current of the second sub-screen 132 to the second target driving current, that is to say, the non-uniform display of the first sub-screen 131 and the second sub-screen 132 can be reduced or eliminated by adjusting the driving current of the first sub-screen 131 and the driving current of the second sub-screen 132 simultaneously, so as to improve the display uniformity of the entire display screen and further improve the display effect.

In the embodiments of the present disclosure, after the driving current of the first sub-screen 131 is adjusted to the first target driving current, and/or the driving current of the second sub-screen 132 is adjusted to the second target driving current, the display brightness when the first target driving current drives the first sub-screen 131 to display may be equal to the display brightness when the second target driving current drives the second sub-screen 132 to display, that is to say, after brightness adjustment, the first sub-screen 131 and the second sub-screen 132 have the same display brightness and have no brightness difference, thereby eliminating the situation of non-uniform display between the first sub-screen 131 and the second sub-screen 132, and improving the display effect of the display screen 13. It should be noted that when only the display brightness of the first sub-screen or the second sub-screen 132 is adjusted, the driving current corresponding to a display area not subjected to the brightness adjustment does not change.

Further, as mentioned above, when the display brightness difference of the display areas of the display screen 13 is small, the user's visual sensitivity is not high, and the user will not perceive that the display brightness of various display area is different. Therefore, after the brightness of each of the display areas is adjusted, the display brightness of the first sub-screen 131 and the display brightness of the second sub-screen 132 may be different, as long as the display brightness is within the preset difference range of the display brightness when the user cannot perceive non-uniform display.

For example, when the display brightness of the first sub-screen 131 and the second sub-screen 132 is adjusted simultaneously, the display brightness when the first target driving current drives the first sub-screen 131 to display can be unequal to the display brightness when the second target driving current drives the second sub-screen 132 to display, as long as the difference between the display brightness of the first sub-screen 131 and the display brightness of the second sub-screen 132 is within the pre-determined difference range which is a maximum brightness difference between the first sub-screen 131 and the second sub-screen 132 when no user's vision disparity is caused. That is to say, when the maximum brightness difference between the first sub-screen 131 and the second sub-screen 132 is within the pre-determined difference range, the display screen 13 in user's eyes is in a uniform display state.

It should be noted that after the brightness of the first sub-screen 131 and/or the second sub-screen 132 in the display screen 13 is adjusted, the uniform display of the first sub-screen 131 and the second sub-screen 132 may be realized, so that the difference between the display brightness of the first sub-screen 131 and the display brightness of the second sub-screen 132 should be smaller than the difference between the display brightness of the first sub-screen 131 and the display brightness of the second sub-screen 132 before the display brightness is adjusted.

As an optional implementation manner, in the embodiment of the present disclosure, when it is determined that the non-uniform display of the first sub-screen 131 and the second sub-screen 132 of the display screen 13 occurs according to the first total display duration of the first sub-screen 131 and the second total display duration of the second sub-screen 132 and it is necessary to adjust the brightness of each display area in the display screen 13, the current driving current of the display area with higher display brightness in the first sub-screen 131 and the second sub-screen 132 can be determined according to the first total display duration of the first sub-screen 131 and the second total display duration of the second sub-screen 132, and the current display brightness of the display area with higher display brightness is determined by a corresponding relationship of a preset display brightness, display duration and driving current according to the total display duration and current driving current of the display area with higher display brightness, and then, based on the current display brightness of the display area with higher display brightness, the target driving current of the display area with lower display brightness in the first sub-screen 131 and the second sub-screen 132 is determined according to the corresponding relationship among the preset display brightness, display duration and driving current, such that after the driving current of the area with lower display brightness is adjusted to the target driving current, the difference between the display brightness corresponding to the display area with lower display brightness and the display brightness of the area with higher display brightness is within the pre-determined range to reduce or even eliminate the non-uniform display of the first sub-screen 131 and the second sub-screen 132, so as to improve the display uniformity of the whole display screen, thereby improving the display effect.

That is to say, the display brightness of the display area with lower display brightness in the first sub-screen 131 and the second sub-screen 132 may be increased, so that the difference between the display brightness of the first sub-screen 131 and the display brightness of the second sub-screen 132 is within the pre-determined difference range.

Specifically, when the first total display duration of the first sub-screen 131 is shorter than the second total display duration of the second sub-screen 132, the first target driving current is smaller than the second target driving current by adjustment. For example, it is assumed that the brightness corresponding to the first sub-screen 131 is 100, the first total display duration is 10,000 hours, the driving current is 3 A, the display brightness of the second sub-screen 132 is 60, the second total display duration is 20,000 hours, and the driving current is 3 A before the display brightness is adjusted, the situation of non-uniform display occurs, where the display brightness of the first sub-screen 131 is higher than that of the second sub-screen 132. Therefore, when the display brightness is adjusted, on the basis that the display brightness of the first sub-screen 131 is 100, it can be determined, from the corresponding relationship of the preset display brightness, display duration and driving current, that the corresponding second target driving current is 3.1 A when the display brightness of the second sub-screen 132 is adjusted to 100, and then the current driving current of the second sub-screen 132 is adjusted from 3 A to 3.1 A.

As an optional implementation manner, when the display brightness is adjusted, the display brightness of the first sub-screen 131 and the display brightness of the second sub-screen 132 can also be within the pre-determined difference rang by reducing the display brightness of the area with higher display brightness in the first sub-screen 131 and the second sub-screen 132, so that uniform display of the first sub-screen 131 and the second sub-screen 132 is realized. As mentioned above, the higher the display brightness is, the larger the driving current is, so that the display brightness of the display area with higher display brightness can be reduced by reducing the driving current of the display area, thereby reducing or eliminating the situation of non-uniform display of the first sub-screen 131 and the second sub-screen 132, so as to improve the display uniformity of the whole display screen, and save electric energy while improving the display effect.

Specifically, when the first total display duration of the first sub-screen 131 is longer than the second total display duration of the second sub-screen 132, the first target driving current is larger than the second target driving current by adjustment. For example, it is assumed that the brightness corresponding to the first sub-screen 131 is 110, the first total display duration is 8,000 hours, the driving current is 2 A, the display brightness of the second sub-screen 132 is 90, the second total display duration is 18,000 hours, and the driving current is 2 A before the display brightness is adjusted, the situation of non-uniform display occurs, where the display brightness of the first sub-screen 131 is higher than that of the second sub-screen 132. Therefore, when the display brightness is adjusted, on the basis that the display brightness of the second sub-screen 132 is 90, it can be determined, from the corresponding relationship of the preset display brightness, display duration and driving current, that the corresponding second target driving current is 1.9 A when the display brightness of the first sub-screen 131 is adjusted to 90, and then the current driving current of the first sub-screen 131 is adjusted from 2 A to 1.9 A.

As an optional implementation manner, when the display brightness is adjusted, too high or too low display brightness increases the burden on user's eyes, so that the first sub-screen 131 and the second sub-screen 132 can be adjusted simultaneously when the brightness is adjusted, namely, a display brightness between the current brightness of the first sub-screen 131 and the current display brightness of the second sub-screen 132, which does not affect watching display contents by the user, is determined, and at the same time, the display brightness of the first sub-screen 131 and the display brightness of the second sub-screen 132 are adjusted to display brightness not affecting watching the displayed contents by the user. Therefore, the situation of non-uniform display of the first sub-screen 131 and the second sub-screen 132 is reduced or eliminated to improve the display uniformity of the whole display screen, which can reduce the burden on user's eyes while improving the display effect.

For example, it is assumed that the brightness corresponding to the first sub-screen 131 is 100, the first total display duration is 10,000 hours, the driving current is 3 A, the display brightness of the second sub-screen 132 is 60, the second total display duration is 20,000 hours, and the driving current is 3A before the display brightness adjusted, the situation of non-uniform display occurs, where the display brightness of the first sub-screen 131 is higher than that of the second sub-screen 132. Therefore, when the display brightness is adjusted, a display brightness value can be set within a brightness range of 60 to 100, for example, 80, then, on the basis that the display brightness is 80, it can be respectively determined, from the corresponding relationship of the preset display brightness, display duration and driving current, that the corresponding first target driving current is 2.95 A when the display brightness of the first sub-screen 131 is adjusted to 80 and the corresponding second target driving current is 3.05 A when the display brightness of the second sub-screen 132 is adjusted to 80, and then, the current driving current of the first sub-screen 131 is adjusted from 3 A to 2.95 A and the current driving current of the second sub-screen 132 is adjusted from 3 A to 3.05 A to reduce or eliminate the situation of non-uniform display of the first sub-screen 131 and the second sub-screen 132, so as to improve the display uniformity of the whole display screen.

As an optional implementation manner, in order to enable the display brightness of the first sub-screen 131 and the display brightness of the second sub-screen 132 of the display screen 13 after brightness adjustment to be more convenient for use by users, and avoid affecting the display effect of the display screen 13 and increasing the burden on user's eyes as the final display brightness after adjustment is too high or the final display brightness after adjustment is too low. In the embodiment of the present disclosure, a pre-determined brightness range can be preset according to the current ambient light intensity of the display screen 13 and the user's using habits, and then, the driving current of the first sub-screen 131 and/or the second driving current of the second sub-screen 132 is adjusted according to the final display brightness of the first sub-screen 131 and the final display brightness of the second sub-screen 132 within the pre-determined brightness range, such that the uniform display of the first sub-screen 131 and the second sub-screen 132 is realized, thereby improving the display effect of the display screen 13.

Those skilled in the art should understand that the embodiments of the present disclosure can be provided as methods, systems, or computer program products. Therefore, the present disclosure may adopt the form of a complete hardware embodiment, a complete software embodiment, or an embodiment combining software and hardware. Moreover, the present disclosure may take the form of a computer program product implemented on one or more computer-available storage media (including but not limited to a disk memory, an optical memory, etc.,) containing computer-available program codes.

The present disclosure is described with reference to flowcharts and/or block diagrams of the method, equipment (system), and computer program product according to the embodiments of the present disclosure. It should be understood that each process and/or block in a flowchart and/or block diagram, and the combination of processes and/or blocks in the flowchart and/or block diagram can be implemented by computer program instructions. These computer program instructions can be provided to the processor of a general-purpose computer, a special-purpose computer, an embedded processor unit or other programmable data processing equipment to produce a machine, so that the instructions executed by a processor of a computer or other programmable data processing equipment produce an apparatus configured to implement the functions specified in one process or multiple processes in the flowchart and/or one block or multiple blocks in the block diagram.

These computer program instructions can also be stored in a computer-readable memory that can guide a computer or other programmable data processing equipment to operate in a specific manner, so that the instructions stored in the computer-readable memory produce an article of manufacture including an instruction apparatus. The instruction apparatus implements the functions specified in one process or multiple processes in the flowchart and/or one block or multiple blocks in the block diagram.

These computer program instructions can also be loaded on a computer or other programmable data processing equipment, so that a series of operating steps are executed on the computer or other programmable equipment to produce computer-implemented processing, so that the instructions executed on the computer or other programmable equipment provide steps configured to implement functions specified in a flow or multiple flows in the flowchart and/or a block or multiple blocks in the block diagram.

Obviously, those skilled in the art can make various modifications and variations to the present disclosure without departing from the spirit and scope of the present disclosure. In this way, if these modifications and variations of the present disclosure fall within the scope of the claims of the present disclosure and equivalent technologies thereof, the present disclosure is also intended to include these modifications and variations.

1. A brightness adjustment method for a display apparatus, comprising:
obtaining a first total display duration of a first sub-screen of a display screen and obtaining a second total display duration of a second sub-screen of the display screen, wherein a folding axis is arranged between the first sub-screen and the second sub-screen; and
controlling a power source chip electrically connected to the first sub-screen and the second sub-screen to provide different supply currents to the first sub-screen and the second sub-screen in response to determining that a difference duration between the first total display duration and the second total display duration meets a preset condition, to enable the first sub-screen and the second sub-screen to be consistent in brightness when being displayed on a same plane.

2. The method according to claim 1, wherein the controlling the power source chip electrically connected to the first sub-screen and the second sub-screen to provide different supply currents to the first sub-screen and the second sub-screen in response to determining that the difference duration between the first total display duration and the second total display duration meets the preset condition comprises:
controlling a supply current provided to the first sub-screen by the power source chip to be larger than a supply current provided to the second sub-screen by the power source chip in response to determining that the first total display duration is longer than the second total display duration.

3. The method according to claim 2, wherein when the supply current provided to the first sub-screen by the power source chip is controlled to be larger than the supply current provided to the second sub-screen by the power source chip, the method further comprises:
controlling the supply current provided to the second sub-screen by the power source chip to be unchanged.

4. The method according to claim 2, further comprising:
controlling the supply current provided to the second sub-screen by the power source chip increased in response to determining that the second total display duration is longer than the first total display duration.

5. The method according to claim 2, wherein the controlling the supply current provided to the first sub-screen by the power source chip to be larger than the supply current provided to the second sub-screen by the power source chip further comprises:
controlling a difference current between the supply current provided to the first sub-screen by the power source chip and the supply current provided to the second sub-screen by the power source chip to be directly proportional to the difference duration.

6. The method according to claim 1, wherein the controlling the power source chip electrically connected to the first sub-screen and the second sub-screen to provide different supply currents to the first sub-screen and the second sub-screen comprises:
controlling the power source chip to provide different supply currents to data lines of the first sub-screen and data lines of the second sub-screen.

7. The method according to claim 1, wherein the obtaining the first total display duration of the first sub-screen of the display screen and obtaining the second total display duration of the second sub-screen of the display screen comprises:
obtaining the first total display duration of the first sub-screen from leaving a factory to a current display moment, and obtaining the second total display duration of the second sub-screen from leaving the factory to the current display moment.

8. A display apparatus, comprising:
a display screen, comprising a first sub-screen, a second sub-screen, and a folding axis between the first sub-screen and the second sub-screen;
a timer electrically to the first sub-screen and the second screen, configured to time a first total display duration of the first sub-screen and a second total display duration of the second sub-screen;
a power source chip electrically connected to the first sub-screen and the second sub-screen; and
a controller electrically to the power source chip, the first sub-screen, the second sub-screen and the timer, configured to obtain the first total display duration and the second total display duration, and control the power source chip to provide different supply currents to the first sub-screen and the second sub-screen in response to determining that a difference duration between the first total display duration and the second total display duration meets a preset condition, to enable the first sub-screen and the second sub-screen to be consistent in brightness when being displayed on a same plane.

9. The display apparatus according to claim 8, wherein the timer comprises a first timer and a second timer;
the first timer is configured to time the first total display duration of the first sub-screen, and the second timer is configured to time the second total display duration of the second sub-screen.

10. The display apparatus according to claim 8, wherein the controller is specifically configured to control the supply current output to the first sub-screen by the power source chip to be larger than the supply current output to the second sub-screen by the power source chip in response to determining that the first total display duration is longer than the second total display duration.

11. The display apparatus according to claim 9, wherein the controller is specifically configured to control the supply current output to the first sub-screen by the power source chip to be larger than the supply current output to the second sub-screen by the power source chip in response to determining that the first total display duration is longer than the second total display duration.
